(19) United States
(12) Patent Application Publication
(10) Pub. No.: US 2014/0208655 A1
(43) Pub. Date: Jul. 31, 2014

(54) SASH CAM FOR SIDE LOAD WINDOW BALANCE SYSTEM

(71) Applicant: AMESBURY GROUP, INC., Amesbury, MA (US)

(72) Inventors: Preston Stoakes, Sioux Falls, SD (US); Chad Swier, Sioux Falls, SD (US); Travis Steen, Sioux Falls, SD (US); Dan Raap, Hartford, SD (US); Gary Newman, Valley Springs, SD (US)

(21) Appl. No.: 14/163,455

(22) Filed: Jan. 24, 2014

Related U.S. Application Data
(60) Provisional application No. 61/756,965, filed on Jan. 25, 2013.

(51) Int. Cl. E05D 13/00; F16H 25/08; E05D 15/06

(52) U.S. Cl. CPC E05D 13/1207; E05D 15/0621; F16H 25/08
USPC 49/445; 74/567

(57) ABSTRACT

A sash cam for a window sash having a base adapted to be secured to a window sash, a cam positionable in a stored position and an engaged position, and a pivot for joining the cam and the base. The pivot is adapted to hold the cam in at least one of the stored position and the engaged position. When in the stored position, a depth of the cam is at least one of less than and equal to a depth of the base.

### CROSS-REFERENCE TO RELATED APPLICATIONS

This application claims priority to and the benefit of U.S. Provisional Patent Application No. 61/756,965, filed Jan. 25, 2013, entitled “SASH CAM FOR SIDE LOAD WINDOW BALANCE SYSTEM,” the disclosure of which is hereby incorporated by reference herein in its entirety.

### INTRODUCTION

Hung window assemblies generally include a window frame forming jamb channels, a lower window sash, an upper window sash, and at least one window balance device for offsetting the weight of a window sash throughout a range of travel within the window frame. Window balance devices use springs, pulleys, or a combination thereof to balance the weight of the window sash at any position within the jamb channels. In side load constant force systems, a constant force coil spring is connected to the window frame proximate the jamb and extends and retracts as the window is lowered and raised.

A side load constant force system provides cost and operational advantages for side load style hung windows. In a side load constant force system, a coil spring extends along a surface of a window jamb (a vertical portion of the window frame) opposite a window sash. The spring is connected directly to a lower portion of the window sash. The compact size leaves “play” or “slop” in the top of the sash, allowing the top of the sash to move side-to-side in the jamb. The motion in the top of the sash can allow the sash to become racked and prevent it from functioning properly. Prior attempted solutions to this racking problem include installing brackets on a top horizontal member of the window sash that slide along the jamb so as to prevent side-to-side movement of the upper portion thereof. These brackets can be unsightly, however, and may interfere with the extension and retraction of the coil spring.

### SUMMARY

In one aspect, the technology relates to a sash cam for a window sash having: a base adapted to be secured to a window sash; a cam positionable in a stored position and an engaged position; and a pivot for joining the cam and the base, wherein the pivot is adapted to hold the cam in at least one of the stored position and the engaged position, wherein when in the stored position, a depth of the cam is at least one of less than and equal to a depth of the base. In an embodiment, the pivot has a projection and the base has a detent for receiving the projection in at least one of the stored position and the engaged position. In another embodiment, the detent has a first detent and a second detent, wherein the first detent is disposed so as to receive the detent when the cam is in the stored position and wherein the second detent is disposed so as to receive the detent when the cam is in the engaged position. In yet another embodiment, the base includes a base plate and a base arm, wherein at least one of the base plate and the base arm defines an opening for receiving a fastener. In still another embodiment, the cam has a cam surface.

In another embodiment of the above aspect, the cam has a first cam surface and a second cam surface spaced from the first cam surface. In an embodiment, the cam further includes a structural element disposed between the first cam surface and the second cam surface. In another embodiment, the first cam surface, the second cam surface, and the structural element at least partially define a gap therebetween. In yet another embodiment, the cam is discrete from the base.

In another aspect, the technology relates to a sash cam unit having: a base adapted to be secured to a window sash, wherein the base has a base depth; and a cam adapted to be positioned in a first position and a second position relative to the base, wherein the cam includes: a cam depth at least one of less than and equal to the base depth; and a cam length greater than the base depth. In an embodiment, the sash cam unit has a pivot connecting the base and the cam. In another embodiment, the sash cam unit includes means for holding the cam in at least one of the first position and the second position. In yet another embodiment, the means for holding is disposed on the pivot and on at least one of the cam and the base. In still another embodiment, the cam has a first cam surface and a second cam surface disposed separate from the first cam surface.

In another embodiment of the above aspect, the cam includes a structural member connecting the first cam surface and the second cam surface, wherein the structural member, the first cam surface, and the second cam surface at least partially define a gap therebetween.

In yet another aspect, the technology relates to a window having: a frame; a sash slidably mounted in the frame, wherein the sash defines a channel; a window balance for controlling movement of the frame relative to the channel; and a sash cam unit having: a base secured within the channel; a cam adapted to be positioned in a stored position and an engaged position relative to the base.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a side view of a sash cam for a side load window balance system, in a stored position.

FIG. 2 is a side view of the sash cam of FIG. 1, in an engaged or deployed position.

FIG. 3 is a top view of the sash cam of FIG. 2.

FIG. 4 is a perspective view of a window sash utilizing a sash cam.

### DETAILED DESCRIPTION

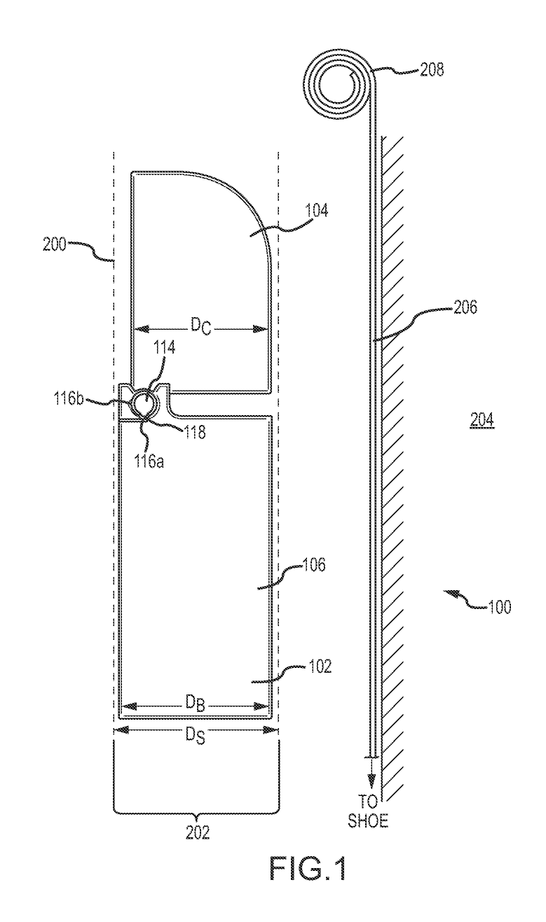

FIGS. 1-3 depict various views of a sash cam unit 100 for a side load window balance system. The sash cam unit 100 includes a base 102 and a cam 104 pivotably connected thereto. The base 102 in this case includes a base plate element 106 and base arm 108 extending therefrom. In the depicted embodiment, the base plate element 106 is connected to a vertical member of a window sash 200. The window sash 200 may be manufactured of wood or vinyl, the latter of which is typically formed of extruded profiles. A channel 202 may be formed in the sash 200 and the sash cam unit 100 may be installed therein. In certain embodiments, the sash cam unit 100 may be secured to the sash 200 via a screw, bolt, or other fastener 110 inserted through one or more openings 112 therein. In other embodiments, adhesives, hooks, or other mechanical fasteners may be used. In the depicted embodiment, the fastener 110 connects the base plate element 106 to the sash 200. In other embodiments, the area of connection may be through the base arm, or both.

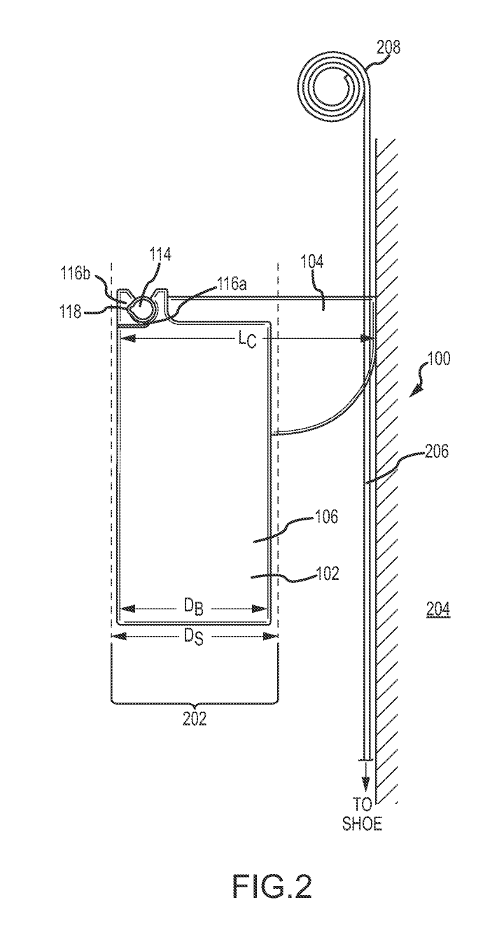

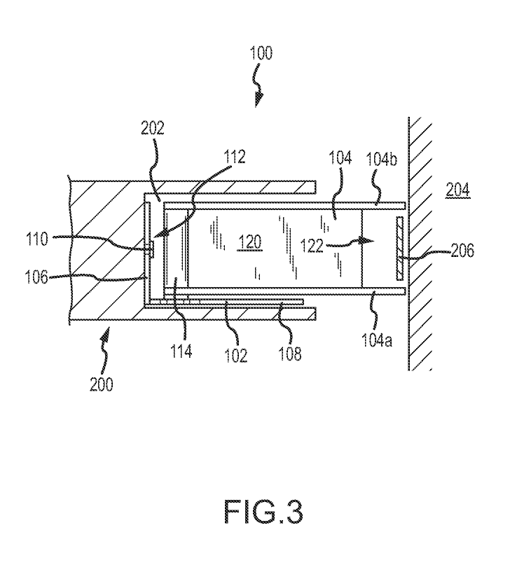

The cam 104 is pivotably connected to the base arm 108 in the depicted embodiment, although other configurations are contemplated. A pivot 114 allows the cam 104 to be positioned in the stored position of FIG. 1, as well as the engaged or deployed position of FIGS. 2 and 3. One or more detents 116 may be used to hold the cam 104 in either or both of the stored and deployed positions. In FIG. 1, a projection 118 on the pivot 114 rests in a first detent 116a on the base arm 108, thus holding the cam 104 in the stored position. In FIG. 2, the projection 118 rests in a second detent 116b, thus holding the cam 104 in the deployed position. In an alternative embodiment, a live hinge (e.g., a molded, elastically deformable element) integral with both of the base 102 and the cam may be utilized instead of a discrete pivot. In another embodiment, the pivot element may be a part discrete from the cam 104 and base 102, or integral with either the cam 104 or the base 102.

The dimensions of the sash cam unit 100 allow it to be easily installed during installation of the window sash 200 while in the stored position, then positioned into the deployed position after installation. In general, the depth D_{B} of the base arm 108 is slightly smaller than the depth D_{S} of the sash channel 202. In the stored position, the depth D_{C} of the cam 104 also is less than the sash channel depth D_{S}, and is less than or equal to the base depth D_{B}. These relative dimensions allow the sash cam unit 100 to be installed easily within the channel 202. Additionally, since the cam D_{C} and D_{B} depth dimensions of the sash cam unit 100 are less than the sash channel depth D_{S}, the cam 104 does not project from the channel 202. Accordingly, the presence of the sash cam unit 100 does not interfere with the installation of the sash 200 into the window frame 204.

FIG. 2 depicts the sash cam unit 100 in the deployed position. Here, the length L_{C} of the cam 104 is greater than the depth D_{B}, D_{S} of both the base 102 and the sash channel 202 respectively. This allows the cam 104 to contact the window frame 204. This contact between the cam and the frame 204 removes slop from the installed window, preventing racking of the sash 200 and improper operation. FIG. 3 depicts a top view of the sash cam unit 100 in the deployed position. As described above, the sash cam unit 100 is secured to the sash 202 with a screw or other fastener 110. As can be seen, the cam 104 defines two cam surfaces 104a, 104b spaced from each other. Proximate the pivot 114, the two cam surfaces 104a, 104b are spanned by a top surface 120 or some other structural member. Distal the pivot 114, a gap 122 is at least partially defined by the two cam surfaces 104a, 104b. The gap 122 is sized to accommodate a coil spring 206 of a window balance. The coil spring 206 extends and retracts from a coil 208, typically supported by a carrier. The orientation of the spring 206 is substantially parallel to the vertical portion of the window frame 204. As depicted in FIGS. 1 and 2, the coil 208 itself may be located in a support (not shown) located proximate an upper portion of the frame 204 as shown. A distal end of the coil 208 is fixed to a shoe. In an alternative embodiment, the coil travels with a carrier secured to the window sash. The sash cam unit 100 described herein may be used with either type of balance, or with other types of balances where elimination or reduction of racking is required or desired.

The gap 122 enables retraction and extension of the coil spring 206 without interference with the cam surfaces 104a, 104b. Of course, the structure and dimension of the window frame 204 may dictate the size of, or even the need for, the gap 122 in the cam 104. For example, a coil spring 206 that is located within a channel in the frame may be sufficiently recessed within the frame such that interference between the cam and the coil spring is unlikely. In that case, then, a gap may not be utilized.

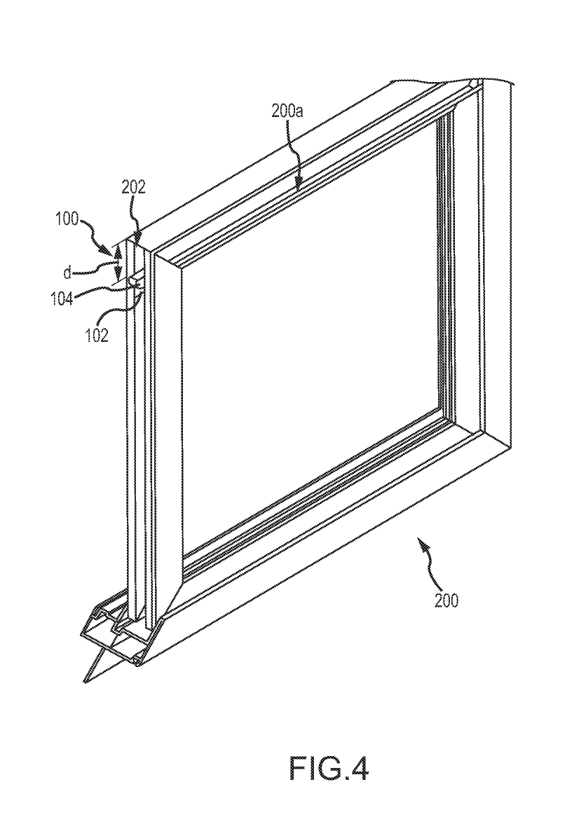

The gap 122 serves at least one other purpose that may make utilization thereof desirable, regardless of the location of the spring. FIG. 4 depicts a perspective view of a window sash 200 with a sash cam unit 100 installed in a channel thereof. As can be seen, the sash cam unit 100 is installed a distance d down from an upper horizontal member 200a of the sash 200 to render it not visible once installed. Once the sash 200 is installed in a window frame, an installer may reach between the sash 200 and the frame and position the sash cam unit 100 in the deployed position. When removing the window, however, it may be difficult to return the cam 104 to the stored position. Accordingly, the gap 122 between the two cam surfaces 104a, 104b provides a gripping surface or catch that may be accessed by an installer, either with a finger or an elongate tool such as a screwdriver or other implement. By accessing the gap 122, the installer may lift the cam 104 from the deployed position to the stored position, allowing for easy removal of the sash 200 from the frame. In alternative embodiments, the cam may include a small projection or hook that may be pulled, or may include a lever located opposite the pivot from the cam surface that may be pushed downward to release the cam to the stored position.

The materials utilized in the manufacture of the ramped sash cam may be those typically utilized for window balance manufacture, e.g., aluminum, zinc, steel, brass, stainless steel, or plastic (such as PVC, polyethylene, nylon, acetal, etc.). Material selection for most of the components may be based on the proposed use of the sash cam. Appropriate materials may be selected for cams subject to certain environmental conditions (e.g., moisture, corrosive atmospheres, etc.).

Although a single top guide/sash cam interface is depicted in the figures, it should be understood that a typical window installation may include one sash cam unit on each side of a window sash. Certain window embodiments may benefit from a single sash cam unit on one side of the sash and a second fixed sash cam on the opposite side. It is likely, however, that the window sash may not sit properly between the window balances if only a single sash cam is used. In certain applications, however, this may be acceptable. Additionally, if the window frame is appropriately configured, a sash cam unit such as the type described herein may be connected thereto, with the cam extending toward the sash away from the window frame.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A sash cam for a window sash comprising:
a base adapted to be secured to a window sash;
a cam positionable in a stored position and an engaged position; and
a pivot for joining the cam and the base, wherein the pivot is adapted to hold the cam in at least one of the stored position and the engaged position, wherein when in the stored position, a depth of the cam is at least one of less than and equal to a depth of the base.

2. The sash cam of claim 1, wherein the pivot comprises a projection the base comprises a detent for receiving the projection in at least one of the stored position and the engaged position.

3. The sash cam of claim 2, wherein the detent comprises a first detent and a second detent, wherein the first detent is disposed so as to receive the detent when the cam is in the stored position and wherein the second detent is disposed so as to receive the detent when the cam is in the engaged position.

4. The sash cam of claim 1, wherein the base comprises a base plate and a base arm, wherein at least one of the base plate and the base arm defines an opening for receiving a fastener.

5. The sash cam of claim 1, wherein the cam comprises a cam surface.

6. The sash cam of claim 1, wherein the cam comprises a first cam surface and a second cam surface spaced from the first cam surface.

7. The sash cam of claim 6, wherein the cam further comprises a structural element disposed between the first cam surface and the second cam surface.

8. The sash cam of claim 7, wherein the first cam surface, the second cam surface, and the structural element at least partially define a gap therebetween.

9. The sash cam of claim 1, wherein the cam is discrete from the base.

10. A sash cam unit comprising:
a base adapted to be secured to a window sash, wherein the base comprises a base depth; and
a cam adapted to be positioned in a first position and a second position relative to the base, wherein the cam comprises:
a cam depth at least one of less than and equal to the base depth; and
a cam length greater than the base depth.

11. The sash cam unit of claim 10, further comprising a pivot connecting the base and the cam.

12. The sash cam unit of claim 11, further comprising means for holding the cam in at least one of the first position and the second position.

13. The sash cam unit of claim 12, wherein the means for holding is disposed on the pivot and on at least one of the cam and the base.

14. The sash cam unit of claim 10, wherein the cam comprises a first cam surface and a second cam surface disposed separate from the first cam surface.

15. The sash cam unit of claim 14, wherein the cam comprises a structural member connecting the first cam surface and the second cam surface, wherein the structural member, the first cam surface, and the second cam surface at least partially define a gap therebetween.

16. A window comprising:
a frame;
a sash slidably mounted in the frame, wherein the sash defines a channel;
a window balance for controlling movement of the frame relative to the channel; and
a sash cam unit comprising:
a base secured within the channel;
a cam adapted to be positioned in a stored position and an engaged position relative to the base.
